(19) United States
(12) Patent Application Publication
(10) Pub. No.: US 2021/0390370 A1
(43) Pub. Date: Dec. 16, 2021

(54) DATA PROCESSING METHOD AND APPARATUS, STORAGE MEDIUM AND ELECTRONIC DEVICE

(71) Applicant: TENCENT TECHNOLOGY (SHENZHEN) COMPANY LIMITED, Shenzhen (CN)

(72) Inventors: Canmiao FU, Shenzhen (CN); Qiong CAO, Shenzhen (CN); Wenjie PEI, Shenzhen (CN); Xiaoyong SHEN, Shenzhen (CN); Yuwing TAI, Shenzhen (CN); Jiaya JIA, Shenzhen (CN)

(73) Assignee: TENCENT TECHNOLOGY (SHENZHEN) COMPANY LIMITED, Shenzhen (CN)

(21) Appl. No.: 17/459,775

(22) Filed: Aug. 27, 2021

Related U.S. Application Data
(63) Continuation of application No. PCT/CN2020/080301, filed on Mar. 20, 2020.

(30) Foreign Application Priority Data
May 31, 2019 (CN) 201910472128.0

(51) Int. Cl. G06N 3/04

(52) U.S. Cl. CPC G06N 3/04

(57) ABSTRACT

A data processing method is provided. In the data processing method, target sequence data is obtained. The target sequence data includes N groups of data sorted in chronological order. Processing is performed, according to an i^{th} group of data in the N groups of data, processing results of a target neural network model for the i^{th} group of data, and a processing result of the target neural network model for a j^{th} piece of data in an (i+1)^{th} group of data, a (j+1)^{th} piece of data in the (i+1)^{th} group of data by using the target neural network model, to obtain a processing result of the target neural network model for the (j+1)^{th} piece of data in the (i+1)^{th} group of data, i being greater than or equal to 1 and less than N, and j being greater than or equal to 1 and less than Q.

### RELATED APPLICATIONS

This application is a continuation of International Application No. PCT/CN2020/080301, entitled “DATA PROCESSING METHOD AND APPARATUS, STORAGE MEDIUM, AND ELECTRONIC APPARATUS” and filed on Mar. 20, 2020, which claims priority to Chinese Patent Application No. 201910472128.0, entitled “DATA PROCESSING METHOD AND APPARATUS, STORAGE MEDIUM AND ELECTRONIC DEVICE” and filed on May 31, 2019. The entire disclosures of the prior applications are hereby incorporated herein by reference in their entirety.

### FIELD OF THE TECHNOLOGY

This disclosure relates to the field of computers, including a data processing method and apparatus, a storage medium and an electronic device.

### BACKGROUND OF THE DISCLOSURE

Currently, sequence data modeling may be applied to visual processing (e.g., video understanding classification and abnormal action detection), text analysis (e.g., sentiment classification), a dialog system, and the like.

Sequence modeling may be performed by using image models. The image models may be divided into two categories: generation models (generative image models) and discrimination models (discriminative image models). A hidden Markov model, as an example of a generation model, may model a potential particular feature for sequence data in a chain. The discrimination model models a distribution of all category labels according to input data. An example of the discrimination model is a conditional random field.

The sequence model may alternatively extract information on a time series based on a recurrent neural network (RNN), for example, perform sequence modeling based on an RNN/long short-term memory (LSTM), which shows excellent performance thereof in many tasks. Compared with the image model, the RNN is easier to be optimized and has a better time modeling capability.

However, a current sequence model has low accuracy in modeling, and consequently is difficult to be widely applied to scenarios such as visual processing, text analysis, and a dialog system.

### SUMMARY

Embodiments of this disclosure include a data processing method and apparatus, a non-transitory computer-readable storage medium, and an electronic device to resolve at least the technical problem in the related art that a sequence model has low accuracy in modeling, and consequently is difficult to be widely applied.

According to an aspect of the embodiments of this application, a data processing method is provided. In the data processing method, target sequence data is obtained. The target sequence data includes N groups of data sorted in chronological order, N being greater than 1. Processing is performed, according to an i^{th} group of data in the N groups of data, processing results of a target neural network model for the i^{th} group of data, and a processing result of the target neural network model for a j^{th} piece of data in an (i+1)^{th} group of data, a (j+1)^{th} piece of data in the (i+1)^{th} group of data by using the target neural network model, to obtain a processing result of the target neural network model for the (j+1)^{th} piece of data in the (i+1)^{th} group of data, i being greater than or equal to 1 and less than N, and j being greater than or equal to 1 and less than Q, Q being a quantity of pieces of data in the (i+1)^{th} group of data.

According to another aspect of the embodiments of this application, a data processing apparatus including processing circuitry is further provided. The processing circuitry is configured to obtain target sequence data, the target sequence data comprising N groups of data sorted in chronological order, N being greater than 1. Further, the processing circuitry is configured to process, according to an i^{th} group of data in the N groups of data, processing results of a target neural network model for the i^{th} group of data, and a processing result of the target neural network model for a j^{th} piece of data in an (i+1)^{th} group of data, a (j+1)^{th} piece of data in the (i+1)^{th} group of data by using the target neural network model, to obtain a processing result of the target neural network model for the (j+1)^{th} piece of data in the (i+1)^{th} group of data, i being greater than or equal to 1 and less than N, and j being greater than or equal to 1 and less than Q, Q being a quantity of pieces of data in the (i+1)^{th} group of data.

According to still another aspect of the embodiments of this application, a non-transitory computer-readable storage medium is further provided. The non-transitory computer-readable storage medium storing instructions which when executed by a processor cause the processor to perform the foregoing method.

According to still another aspect of the embodiments of this application, an electronic device is further provided. The electronic device includes a memory, a processor, and a computer program being stored on the memory and executable on the processor, the processor performing the foregoing method by using the computer program.

According to still another aspect of the embodiments of this application, a computer program product is further provided, the computer program product, when run on a computer, causing the computer to perform the foregoing data processing method.

In the embodiments of this application, the (j+1)^{th} piece of data in the (i+1)^{th} group of data is processed, by using a target neural network model, according to the i^{th} group of data in N groups of data included in target sequence data, processing results of the target neural network model for the i^{th} group of data, and a processing result of the target neural network model for the j^{th} piece of data in the (i+1)^{th} group of data. Because the target neural network model (for example, an LSTM model) processes inputted current data (that is, the (j+1)^{th} piece of data in the (i+1)^{th} group of data) not only based on obtaining of information of an adjacent time step (a previous processing result, that is, the processing result for the j^{th} piece of data in the (i+1)^{th} group of data), but also based on a previous group of data of a current group of data (that is, the i^{th} group of data) and processing results for the previous group of data (a previous group of processing results, that is, the processing results for the i^{th} group of data), so that a long-term dependency relationship can be captured and modeled, thereby resolving a problem of low modeling accuracy caused by that a sequence model in the related art cannot model a long-term dependency relationship. A model obtained based on the foregoing method can be widely applied to scenarios such as visual processing, text analysis, and a dialog system.

### BRIEF DESCRIPTION OF THE DRAWINGS

The accompanying drawings described herein are used to provide a further understanding of this disclosure, and form part of this disclosure. Exemplary embodiments of this disclosure and descriptions thereof are used to explain this disclosure, and do not constitute any inappropriate limitation to this disclosure. In the accompanying drawings:

FIG. 1 is a schematic diagram of an application environment of a data processing method according to an embodiment of this disclosure.

FIG. 2 is a schematic flowchart of an exemplary data processing method according to an embodiment of this disclosure.

FIG. 3 is a schematic diagram of an exemplary target neural network model of a data processing method according to an embodiment of this disclosure.

FIG. 4 is a schematic diagram of an exemplary target neural network model of a data processing method according to an embodiment of this disclosure.

FIG. 5 is a schematic diagram of an exemplary target processing model according to an embodiment of this disclosure.

FIG. 6 is a schematic diagram of exemplary target sequence data according to an embodiment of this disclosure.

FIG. 7 is a schematic diagram of exemplary target sequence data according to an embodiment of this disclosure.

FIG. 8 is a schematic diagram of an exemplary target neural network model according to an embodiment of this disclosure.

FIG. 9 is a schematic diagram of an exemplary nonlocal recurrent memory cell according to an embodiment of this disclosure.

FIG. 10 is a schematic diagram of an exemplary data processing method according to an embodiment of this disclosure.

FIG. 11 is a schematic structural diagram of an exemplary data processing apparatus according to an embodiment of this disclosure.

FIG. 12 is a schematic structural diagram of an exemplary electronic device according to an embodiment of this disclosure.

### DESCRIPTION OF EMBODIMENTS

To make a person skilled in the art better understand the solutions of this disclosure, the following describes technical solutions in the embodiments of this disclosure with reference to the accompanying drawings in the embodiments of this disclosure. The described embodiments are only some rather than all of the embodiments of this disclosure. All other embodiments obtained by a person of ordinary skill in the art based on the embodiments of this disclosure shall fall within the protection scope of this disclosure.

In this specification, claims, and accompanying drawings of this disclosure, the terms “first”, “second”, and so on are intended to distinguish similar objects but do not necessarily indicate a specific order or sequence. It is to be understood that the data termed in such a way are interchangeable in appropriate circumstances, so that the embodiments of this disclosure described herein can be implemented in orders other than the order illustrated or described herein. Moreover, the terms “include”, “contain” and any other variants mean to cover the non-exclusive inclusion, for example, a process, method, system, product, or device that includes a list of steps or units is not necessarily limited to those expressly listed steps or units, but may include other steps or units not expressly listed or inherent to such a process, method, system, product, or device.

A sequence model in the related art can only capture information in adjacent time steps in a sequence, and explicitly model first-order information exchange between adjacent time steps in the sequence. Because high-order information exchange between non-adjacent time steps cannot be captured, the high-order information exchange between non-adjacent time steps is not fully used.

In an actual application, there may be thousands of time steps in one piece of sequence data, and in first-order information exchange, because information cannot be processed due to gradual dilution and gradient diffusion over time, a long-term dependency relationship cannot be modeled. This limits a modeling capability of the model for long-term dependency data, and consequently limits a processing capability of the model for a long-distance time dependency problem.

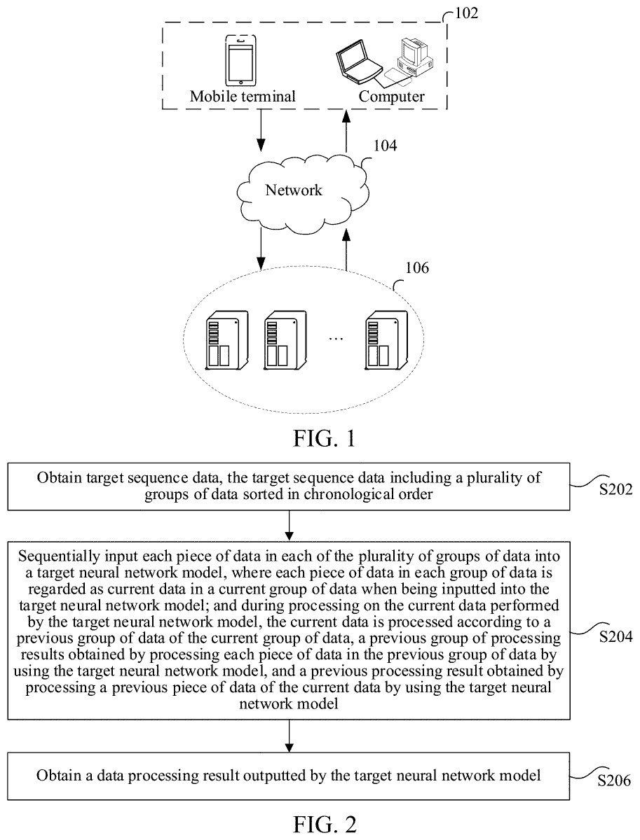

To resolve the foregoing problems, according to an aspect of the embodiments of this disclosure, a data processing method is provided. The data processing method may be applied to an application environment shown in FIG. 1, but this disclosure is not limited thereto. As shown in FIG. 1, the data processing method relates to interaction between a terminal device 102, such as a mobile terminal or a computer, and a server 106 by using a network 104.

The terminal device 102 may acquire target sequence data or obtain target sequence data from another device, and send the target sequence data to the server 106 by using the network 104. The target sequence data includes a plurality of groups of data sorted in chronological order.

After obtaining the target sequence data, the server 106 may sequentially input each piece of data in each of the plurality of groups of data into a target neural network model, and obtain a data processing result outputted by the target neural network model. During processing on current data performed by the target neural network model, the current data is processed according to a previous group of data of a current group of data, a previous group of processing results obtained by processing each piece of data in the previous group of data by using the target neural network model, and a previous processing result obtained by processing a previous piece of data of the current data by using the target neural network model.

In some embodiments, after obtaining the data processing result, the server 106 may determine an execution result of a target task according to the data processing result, and send the determined execution result to the terminal device 104 by using the network 104. The terminal device 104 stores the execution result, and may further present the execution result.

FIG. 1 provides a description by using an example in which the server 106 performs, by using the target neural network model, the foregoing processing on each piece of data included in each group of data in the target sequence data (including N groups of data sorted in chronological order, N being greater than 1). In some possible implementations, during processing, the server 106 may determine an execution result of a target task based on a processing result for a piece of data in a group of data. In this case, the server 106 may not perform a processing process on data after the piece of data in the target sequence data, and end a current processing process.

That is, the server 106 may perform the foregoing processing process for a part of data in the target sequence data by using the target neural network model. For ease of understanding, a description is made below by using a processing process for the (j+1)^{th} piece of data in the (i+1)^{th} group of data.

For example, the server 106 first obtains the i^{th} group of data and processing results of the target neural network model for the i^{th} group of data, and obtains a processing result of the target neural network model for the j^{th} piece of data in the (i+1)^{th} group of data. Then the server 106 processes, according to the i^{th} group of data, the (j+1)^{th} piece of data in the (i+1)^{th} group of data by using the target neural network model, the processing results of the target neural network model for the i^{th} group of data, and the processing result of the target neural network model for the j^{th} piece of data in the (i+1)^{th} group of data, to obtain a processing result of the target neural network model for the (j+1)^{th} piece of data in the (i+1)^{th} group of data.

i is greater than or equal to 1 and less than N, and j is greater than or equal to 1 and less than Q, Q being a quantity of pieces of data in the (i+1)^{th} group of data.

For the first group of data, a previous group of data of the first group of data and processing results of the previous group of data may be regarded as 0, and then processing may be performed in the foregoing processing manner. For the first piece of data in each group of data, a processing result for a previous piece of data of the first piece of data may be regarded as 0, and then processing may be performed in the foregoing processing manner.

The target task may include, but is not limited to, video understanding classification, abnormal action detection, text analysis (e.g., sentiment classification), a dialog system, and the like.

In some embodiments, the terminal device may include, but is not limited to, at least one of the following: a mobile phone, a tablet computer, and the like. The network may include, but is not limited to, at least one of the following: a wireless network and a wired network. The wireless network includes: Bluetooth, Wi-Fi, and/or another network implementing wireless communication, and the wired network may include: a local area network, a metropolitan area network, a wide area network, and/or the like. The server may include, but is not limited to, at least one of the following: a device configured to process a target sequence model by using the target neural network model. The foregoing description is merely an example, and no limitation is imposed in this embodiment.

In an exemplary implementation, as shown in FIG. 2, the data processing method may include the following steps.

In step S202, target sequence data is obtained, the target sequence data including N groups of data sorted in chronological order.

In step S204, each piece of data in each of the N groups of data is sequentially input into a target neural network model, where each piece of data in each group of data is regarded as current data in a current group of data when being inputted into the target neural network model. During processing on the current data performed by the target neural network model, the current data is processed according to a previous group of data of the current group of data, a previous group of processing results obtained by processing each piece of data in the previous group of data by using the target neural network model, and a previous processing result obtained by processing a previous piece of data of the current data by using the target neural network model.

In step S206, a data processing result outputted by the target neural network model is obtained.

Similar to FIG. 1, FIG. 2 provides a description by using an example in which the foregoing processing is performed on each piece of data in the N groups of data in the target sequence data. During an actual application, the foregoing processing may be performed on several pieces of data in the target sequence data. This is not limited in this embodiment.

The data processing method may be applied to a process of executing a target task by using a target neural network, but this disclosure is not limited thereto. The target task may be to determine an execution result of a target task according to information of the target sequence data on a time series. For example, the target task may be video understanding classification, abnormal action detection, text analysis (e.g., sentiment classification), a dialog system, or the like.

Action classification is used as an example. Video data is a type of sequence data, and each piece of data is a video frame (a video image). The video data is inputted into a target neural network model, to obtain a processing result for the video data. An action performed by an object in the video data may be determined from a group of actions according to the processing result for the video data, for example, walking toward each other.

Sentiment recognition is used as an example. There is a sequence within a sentence and between sentences in text data (e.g., a commodity review, where a commodity may be an actual product, a virtual service, or the like), and the text data may be regarded as data sorted in chronological order. The text data is inputted into the target neural network model, to obtain a processing result for the text data. A sentiment tendency of the text data can be determined from a group of sentiments according to the processing result for the text data, for example, a positive sentiment (positive review) or a negative sentiment (negative review).

The data processing method in this embodiment is described below with reference to FIG. 2.

In step S202, target sequence data is obtained, the target sequence data including N groups of data sorted in chronological order.

A server (or a terminal device) may be configured to execute a target task. The target task may be video understanding classification (e.g., action recognition), text analysis (e.g., sentiment analysis), or a dialog system. The server may analyze the target sequence data related to the target task, to determine an execution result of the target task.

The target sequence data may include a plurality of pieces of data sorted in chronological order. There may be a plurality of cases for sorting the target sequence data in chronological order. For example, for video data, video frames (images) in the video data are sorted in chronological order; and for text data, words may be sorted in a sequence in which the words in text appear. A word is a language unit that can be independently used. A word may be a single-character word such as “ [symbol] ” or “ [symbol] ”, and may alternatively be a non-single-character word such as or “ [symbol] ” or “ [symbol] ”. At least one word may form a phrase through combination, at least one phrase may form a sentence through combination in sequence, and at least one sentence may form text through combination in sequence.

In an exemplary implementation, the obtaining target sequence data includes: obtaining target video data, the target video data including N video frame groups sorted in chronological order and being used for recognizing an action performed by a target object in the target video data.

In an exemplary implementation, the obtaining target sequence data includes: obtaining target text data, the target text data including at least one sentence, the at least one sentence including N sequential phrases, and the target text data being used for recognizing a sentiment class expressed by the target text data.

By using the foregoing technical solutions in this embodiment of this disclosure, different target sequence data is obtained for different types of target tasks, so that different types of task requirements can be met, thereby improving applicability of the sequence model.

After the target sequence data is obtained, the target sequence data may be divided into groups. The target sequence data may be divided into a plurality of data in chronological order.

In some embodiments, after the target sequence data is obtained, a target sliding window is used to slide on the target sequence data according to a target stride, to obtain a plurality of groups of data.

To ensure processing efficiency of the sequence model, a size of the target sliding window may be set to be the same as the target stride. To ensure processing accuracy of the sequence model, the size of the target sliding window may be set to be greater than the target stride.

For different types of target sequence data or different target sequence data, the size of the used target sliding window and the target stride may be the same or different. The same target sequence data may be sampled by using a plurality of sizes of the target sliding window and a plurality of target strides.

For example, acquisition of the target sequence data (sliding of the target sliding window) and data processing performed by using the target neural network model may be sequentially performed. Each time the target sliding window slides, a group of data is obtained, and the group of data is processed by using the target neural network model. After the group of data is processed by using the target neural network model, the size of the target sliding window and the target stride may be adjusted (may alternatively not be adjusted), to obtain a next group of data, and the next group of data is processed by using the target neural network model, until all of the target sequence data is processed.

For the last group of data in the target sequence data, a quantity of pieces of data included in the last group of data may be less than a size of the target sliding window. Because data is sequentially inputted into the target neural network model for processing, the quantity of pieces of data included in the last group of data does not affect processing on the data by the target neural network model.

By using the foregoing technical solutions in this embodiment of this disclosure, the target sliding window is used to slide on the target sequence data according to the target stride, to obtain a plurality of groups of data, which facilitates dividing the target sequence data into groups, thereby improving processing efficiency for the target sequence data.

In step S204, each piece of data in each of the plurality of groups of data is sequentially input into a target neural network model, where each piece of data in each group of data is regarded as current data in a current group of data when being inputted into the target neural network model. During processing on the current data performed by the target neural network model, the current data is processed according to a previous group of data of the current group of data, a previous group of processing results obtained by processing each piece of data in the previous group of data by using the target neural network model, and a previous processing result obtained by processing a previous piece of data of the current data by using the target neural network model.

After the plurality of groups of data (all or some of the plurality of groups of data) are obtained, each piece of data in each of the plurality of obtained groups of data may be sequentially inputted into the target neural network model for processing the each piece of data by using the target neural network model.

The target neural network model has the following feature: sequentially processing each piece of inputted data may be processing the current data according to at least a processing result for a previous piece of captured data. The target neural network model may be an RNN model, and a used RNN may include at least one of the following: an RNN, an LSTM, a high-order RNN, and a high-order LSTM.

For the first group of data in the plurality of groups of data, current data in the first group of data may be sequentially inputted into the target neural network model, and the current data may be processed by using a processing result for a previous piece of data of the current data (a previous processing result), to obtain a processing result for the current data (a current processing result). When the current data is the first piece of data in the first group of data, the current data is inputted into the target neural network model for processing.

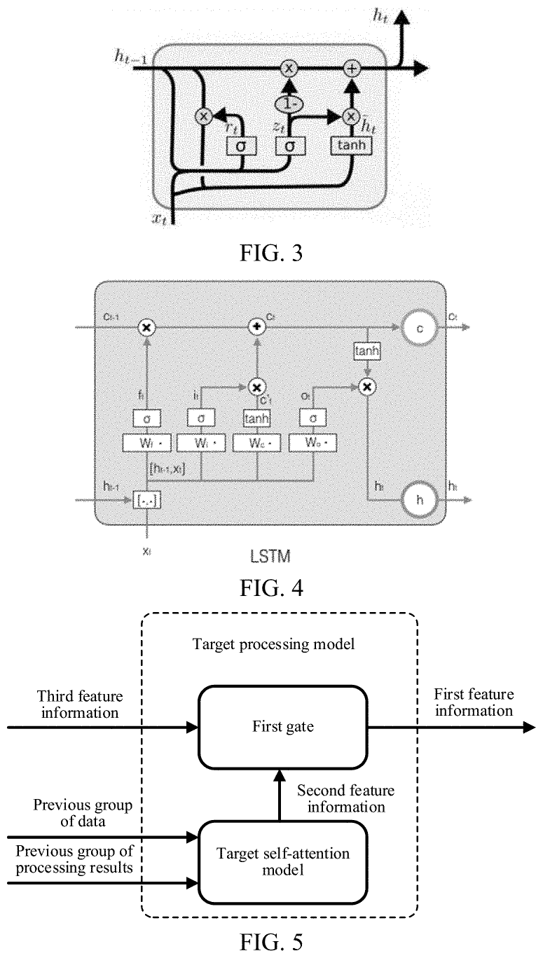

For example, when the target neural network model includes an RNN (as shown in FIG. 3), a processing result obtained by processing the first group of data by using the target neural network model is the same as a processing result obtained by processing the first group of data by using the RNN included in the target neural network model.

For example, when the target neural network model includes an LSTM, a processing result obtained by processing the first group of data by using the target neural network model is the same as a processing result obtained by processing the first group of data by using the LSTM (as shown in FIG. 4).

In some embodiments, the sequentially inputting each piece of data in each of the plurality of groups of data into a target neural network model may include: obtaining a previous group of data, a previous group of processing results, and a previous processing result; and inputting current data into the target neural network model, to obtain a current processing result that is outputted by the target neural network model and that corresponds to the current data, where during processing on the current data performed by the target neural network model, the current data is processed according to the previous group of data, the previous group of processing results, and the previous processing result.

By using the foregoing technical solutions in this embodiment of this disclosure, the previous group of data, the previous group of processing results (a group of processing results obtained by processing each piece of data in the previous group of data by using the target neural network model), and the previous processing result (a processing result obtained by processing the previous piece of data by using the target neural network model) are obtained, and the current data is processed according to the previous group of data, the previous group of processing results, and the previous processing result by using the target neural network model, to obtain the processing result corresponding to the current data. In this way, processing on the current data can be completed, thereby completing a processing process of the target neural network model.

For a group of data (a current group of data) in the plurality of groups of data other than the first group of data, a previous group of data of the current data, a previous group of processing results obtained by processing each piece of data in the previous group of data by using the target neural network model (each piece of data in the previous group of data and each processing result in the previous group of processing results may be in a one-to-one correspondence), and a previous processing result obtained by processing a previous piece of data of the current data by using the target neural network model may be first obtained.

The previous group of data and the previous group of processing results may be used as a whole (e.g., high-dimensional feature information of the previous group of data is extracted) acting on the target neural network model: the previous group of data and the previous group of processing results may be first processed by using a target processing model, to obtain target feature information (first feature information).

The target feature information may be obtained according to the previous group of data and the previous group of processing results: the previous group of data and the previous group of processing results may be inputted into a target self-attention model in the target processing model, to obtain second feature information that is outputted by the target self-attention model and that corresponds to the previous group of data. The second feature information may be outputted as target feature information.

Because the target feature information is generated with reference to the previous group of data and the processing results of the previous group of data, information of the sequence data can be circulated among a plurality of data segments. Therefore, a longer-term dependency relationship can be captured, thereby modeling global interaction among the data segments.

In addition to the second feature information, the target feature information may alternatively be obtained according to processing results of one or more groups of data previous to the previous group of data.

In some embodiments, the inputting current data into the target neural network model, to obtain a current processing result that is outputted by the target neural network model and that corresponds to the current data includes: obtaining first feature information data that is outputted by a target processing model and that corresponds to a previous group and a previous processing result, the target processing model including a target self-attention model and a first gate, the first feature information being obtained by inputting second feature information and third feature information into the first gate, the second feature information being obtained by inputting the previous group of data and a previous group of processing results into the target self-attention model, the third feature information being feature information that is outputted by the target processing model and that corresponds to the previous group of data, the third feature information being intra-group feature information of the previous group of data (the i^{th} group of data), and the first feature information being feature information that is outputted by the target processing model and that corresponds to a current group of data, and being intra-group feature information of the current group of data (the (i+1)^{th} group of data), and the first gate being configured to control a proportion of the second feature information outputted to the first feature information and a proportion of the third feature information outputted to the first feature information; and inputting the current data into the target neural network model, to obtain a current processing result, where during processing on the current data performed by the target neural network model, the current data is processed according to the first feature information and the previous processing result.

In addition to the second feature information, the target feature information may alternatively be generated according to the feature information (third feature information) corresponding to the previous group of data that is outputted by the target processing model.

For example, as shown in FIG. 5, the previous group of data (the i^{th} group of data) and the previous group of processing results (processing results for the i^{th} group of data) are inputted into the target self-attention model in the target processing model, to obtain second feature information; and third feature information obtained by processing the previous group of data by using the target processing model is also inputted into a first gate. The first gate controls parts of the second feature information and the third feature information that are outputted to the first feature information (the first gate controls which information is retained, a retaining degree, and which information is discarded), to obtain the first feature information (the target feature information).

By using the foregoing technical solutions in this embodiment of this disclosure, a relationship between the previous group of data and the previous group of processing results and an information matching degree between processing results in the previous group of processing results are modeled by using the target self-attention model, and the first gate is used to control an information process among sequence data segments, thereby ensuring accuracy in modeling of a long-term dependency relationship.

After the first feature information is obtained, the obtained first feature information may sequentially act on a process of processing each piece of data of the current group of data by using the target neural network model.

In some embodiments, in a process of inputting the current data into the target neural network model, to obtain the current processing result, the first feature information and the current data may be inputted into a second gate, to obtain a target parameter, the second gate being configured to control a proportion of the first feature information outputted to the target parameter and a proportion of the current data outputted to the target parameter; and the target parameter may be inputted into the target neural network model, to control an output of the target neural network model.

By using the foregoing technical solutions in this embodiment of this disclosure, a gate (the second gate) is added to a target neural network, to introduce target feature information for updating a current hidden state, so that long-distance sequence information can also be well captured in a current time step.

In step S206, a data processing result outputted by the target neural network model is obtained.

After each piece of data in the target sequence data is processed, a processing result of the target neural network model for the last piece of data may be outputted as a final result of the processing on the target sequence data.

After the data processing result outputted by the target neural network model is obtained, the data processing result may be analyzed, to obtain an execution result of a target task. The target task may include, but is not limited to, information flow recommendation, video understanding, a dialog system, sentiment analysis, and the like.

In an exemplary implementation, after the data processing result (which may be a processing result for a piece of data in the target sequence data, including a processing result for the last piece of data) outputted by the target neural network model is obtained, first probability information (which may include a plurality of probability values respectively corresponding to reference actions in a reference action set) may be determined according to the data processing result, the first probability information being used for representing a probability that an action performed by a target object is each reference action in a reference action set; and it is determined according to the first probability information that the action performed by the target object is a target action in the reference action set.

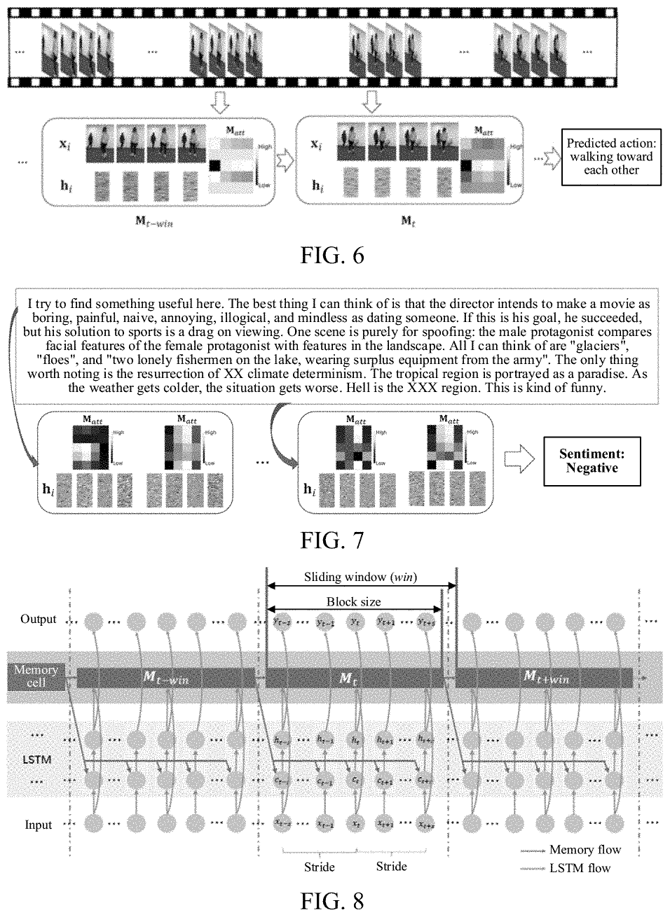

The data processing method is described below with reference to some examples. As shown in FIG. 6, the target sequence data is a segment of video data. The video data includes a plurality of video frames. A target task is to recognize an action of a person in the video clip. An action shown in the video in this example is “walking toward each other”.

The plurality of video frames are divided into a plurality of video frame groups according to a size of a sliding window in a manner in which every N video frames form one group (e.g., every five or ten video frames form one group). Each video frame in each of the plurality of video frame groups is sequentially inputted into the target neural network model. For each video frame group, after the last video frame is processed, second feature information may be obtained according to an inputted video frame (xᵢ) and an outputted processing result (hᵢ), and further, first feature information is obtained. After all the video frames are processed, the action shown in the video is predicted, according to a processing result for the last video frame, to be “walking toward each other”.

A change of a relative distance between two people over time is a key to behavior recognition, and the target neural network model can successfully capture the change of the relative distance between the two people over time, so that the action can be correctly recognized. For models such as an LSTM, because the change of the relative distance between the two people over time cannot be successfully captured, the action cannot be correctly recognized. Instead, the action is mistakenly recognized as “hitting each other”.

In another exemplary implementation, after the data processing result (which may be a processing result for a piece of data in the target sequence data, including a processing result for the last piece of data) outputted by the target neural network model is obtained, second probability information (which may include a plurality of probability values respectively corresponding to reference sentiment classes in a reference sentiment class set) may be determined according to the data processing result, the second probability information being used for representing a probability that a sentiment class expressed by target text data is each reference sentiment class in the reference sentiment class set; and it is determined according to the second probability information that the sentiment class expressed by target text data is a target sentiment class in the reference sentiment class set.

As shown in FIG. 7, the target sequence data is a review. The review includes a plurality of sentences. A target task is to recognize a sentiment class in a particular review. A sentiment class of the review in this example is “negative”.

The review is divided into a plurality of sentence groups according to a size of a sliding window in a manner in which every N sentences form one group (e.g., every two or three sentences form one group). Actually, the sentence group may alternatively be a combination of words. Therefore, the sentence group may alternatively be regarded as a type of phrase. Each sentence in each of the plurality of sentence groups is sequentially inputted into the target neural network model. For each sentence group, after the last sentence is processed, second feature information may be obtained according to an inputted sentence (xᵢ) and an outputted processing result (hᵢ), and further, first feature information is obtained. After all the sentences are processed, a sentiment class in the review is predicted according to a processing result for the last sentence to be negative.

For this review, the first several sentences (“I try to . . . someone”) is an important clue for a negative review tendency. Because the sentences are easy to be forgotten by a hidden state hᵢₜ in the last time step, the sentences are difficult to be captured by an LSTM. The last several sentences (The only thing worth noting is . . . It's kind of funny) in the review show a positive review tendency, which misleads the LSTM model in recognition. Consequently, the LSTM model recognizes a sentiment class of the review as: positive.

By using the foregoing technical solutions in this embodiment of this disclosure, execution results of different types of target tasks are determined for the target tasks, so that different types of task requirements can be met, thereby improving applicability of the sequence model.

In this embodiment, each piece of data in target sequence data is sequentially inputted into a target neural network model, and the target neural network model processes current data according to a previous group of data of a current group of data, a previous group of processing results obtained by processing the previous group of data by using the target neural network model, and a previous processing result obtained by processing a previous piece of data of the current data by using the target neural network model; and a data processing result outputted by the target neural network model is obtained, so that a problem that a sequence model in the related art cannot model a long-term dependency relationship is resolved, and a long-term dependency relationship is captured, thereby modeling the long-term dependency relationship.

FIG. 6 shows a processing result for the last video frame. FIG. 7 provides a description by using the processing result for the last sentence as an example. During an actual application, the server 106 may alternatively execute the foregoing task based on processing results of other video frames or other sentences.

The data processing method is described below with reference to examples. For the problem that a long-distance time dependency relationship cannot be processed by using a current sequence modeling algorithm, the target neural network model used in the data processing method in this example may be an LSTM model based on local recurrent memory.

The target neural network model may perform full-order modeling in a sequence data segment and model global interaction among sequence data segments. As shown in FIG. 8, the target neural network model mainly includes two parts: a nonlocal recurrent memory cell and a sequence model (sequence modeling).

(1) Nonlocal Recurrent Memory Cell

The nonlocal recurrent memory cell can learn high-order interaction between hidden states of the target neural network model (e.g., an LSTM) in different time steps within each sequence data segment (memory block). In addition, the global interaction between memory blocks is modeled in a gated recurrent manner. A memory state learned from each memory block acts on a future time step in return, and is used for tuning a hidden state of the target neural network model (e.g., an LSTM), to obtain a better feature representation.

The nonlocal recurrent memory cell may be configured to process full-order interaction within a sequence data segment, extract high-dimensional features (e.g., M_{t-win}, Mₜ, and M_{t+win}) within the data segment, and implement memory flows (e.g., M_{t-win}→Mₜ→M_{t+win} and M_{t-win}→Cₜ,Cₜ₋₁) among data segments.

M_{t-win}, Mₜ, and M_{t+win} shown in FIG. 8 are nonlocal recurrent memory cells corresponding to different inputted data groups. As shown in FIG. 8, a memory cell corresponding to a previous group of data can act on a processing process of each piece of data in a current group of data.

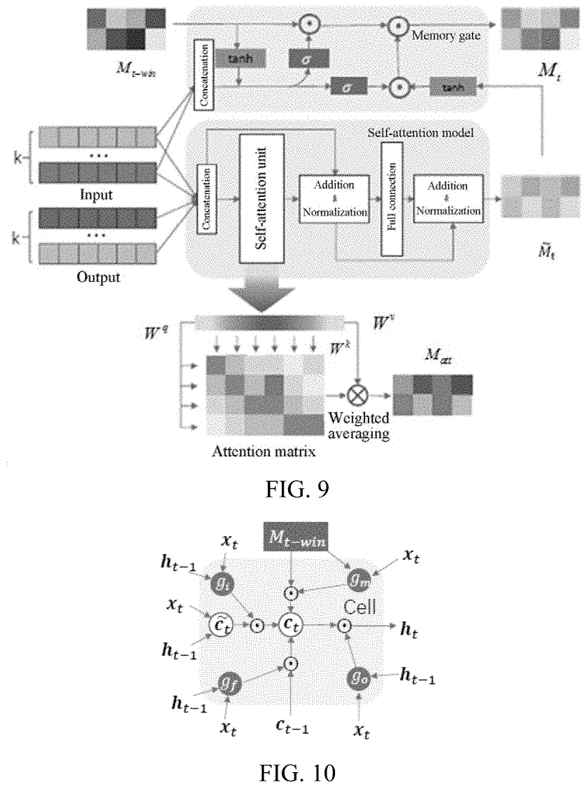

Within a sequence data segment (data group with a block size shown in FIG. 8), considering input data x and an output h of an LSTM model, the nonlocal recurrent memory cell may implicitly model a relationship between the input data x and the output h of the LSTM model and an information matching degree between every two h's by using a self-attention mechanism (as shown in FIG. 9), to obtain a current high-dimensional feature \tilde{M}ₜ, and simultaneously control information circulation among sequence data segments by using a memory gate.

A structure of the nonlocal recurrent memory cell may be shown in FIG. 9. The nonlocal recurrent memory cell may include two parts: a self-attention model (which is also referred to as an attention module, of which a function is the same as that of the foregoing target self-attention model), configured to model a relationship between input information and purify features; and a memory gate (of which a function is the same as that of the foregoing first gate), configured to control flowing of information on different time steps, to avoid information redundancy and overfitting.

As shown in FIG. 9, a process of obtaining Mₜ corresponding to a current group of data (a current data segment, xₜ₋ₛ, . . . xₜ . . . xₜ₊ₛ) by the nonlocal recurrent memory cell is as follows:

First, a previous group of data (inputs, xₜ₋ₛ, . . . xₜ . . . xₜ₊ₛ) and a previous group of processing results (outputs, hidden states, hₜ₋ₛ, . . . hₜ . . . hₜ₊ₛ) are inputted into the self-attention model, to obtain \tilde{M}ₜ.

After obtaining the inputs (each input may be represented as a feature vector) and the hidden states (each hidden state may be represented as a feature vector), the self-attention model may concatenate the inputs and the hidden states, to obtain a first concatenated data (AttentionMask, an attention matrix, which may be represented as a feature vector matrix).

Self-attention processing is performed on the first concatenated data. The first concatenated data (AttentionMask) is processed according to importance of feature vectors, to perform association between the feature vectors, which may include: using three predefined parameter matrices W^{q}, W^{k}, and W^{v} to process the AttentionMask, to obtain Mₐₜₜ, where Mₐₜₜ is an attention weight matrix of visual memory blocks.

After Mₐₜₜ is obtained, addition and normalization (Add&Norm) may be performed on Mₐₜₜ and AttentionMask, to obtain second concatenated data; the second concatenated data is fully connected, to obtain third concatenated data; and then addition and normalization (Add&Norm) are performed on the second concatenated data and the third concatenated data, to obtain \tilde{M}ₜ.

Then Mₜ is obtained according to \tilde{M}ₜ, or M_{t-win} and \tilde{M}ₜ.

In an exemplary implementation, after \tilde{M}ₜ is obtained, \tilde{M}ₜ may be outputted as Mₜ.

A sequence model in the related art performs processing for adjacent time steps, and cannot perform long-distance time span modeling. In the technical solution in this example, the target neural network model may perform modeling of high-order information, that is, can perform full-order modeling on interaction among all time steps within a sequence data segment, and can also model global interaction among data segments. Therefore, the target neural network model can capture a longer-term dependency relationship.

In another exemplary implementation, after \tilde{M}ₜ is obtained, M_{t-win} and \tilde{M}ₜ may be inputted into a memory gate (of which a function is the same as the foregoing first gate), and an output of the memory gate is used as Mₜ. The memory gate controls information circulation among sequence data segments.

By using the technical solution in this example, the target neural network model can learn potential high-dimensional features included in high-order interaction between non-adjacent time steps, thereby enhancing high-dimensional feature extraction.

(2) Sequence Model (Sequence Modeling)

The nonlocal recurrent memory cell may be embedded into a current sequence data processing model, for example, an LSTM, to improve a long sequence data modeling capability of the current sequence data processing model.

The nonlocal recurrent memory cell (also referred to as a nonlocal memory cell) can be seamlessly integrated into an existing sequence model having a recursive structure, for example, an RNN, a GRU, or an LSTM (FIG. 8 shows a target neural network model obtained by embedding the nonlocal memory cell into an LSTM model), so that a sequence modeling capability in an existing sequence model (e.g., video understanding and a dialog system) can be enhanced, and peer-to-peer training can be performed on an integrated model. Therefore, the nonlocal recurrent memory cell can have a good migration capability.

For example, the nonlocal recurrent memory cell can be seamlessly integrated into a model on a current service line (e.g., an LSTM), to reduce costs of secondary development to the utmost extent. As shown in FIG. 10, an LSTM is used as an example. A gate gₘ (of which a function is the same as that of the second gate) is directly added to an LSTM model by modifying a cell of the LSTM, to introduce M_{t-win} for updating a current hidden state, so that long-distance sequence information can also be well captured in a current time step.

For each update of information, reference is made to information M_{t-win} of a previous sequence data segment, to ensure that information can be circulated among sequence data segments, that is, a relationship on a long-distance sequence can be captured, thereby effectively improving performance of the model. In addition, the nonlocal recurrent memory cell can be quite conveniently embedded into the current model, thereby reducing development costs to the utmost extent.

In addition, to avoid overfitting and information redundancy, the target neural network model also supports information sampling based on different strides, and further supports dynamic (sliding window) feature updating.

In the technical solution in this example, by using a nonlocal recurrent memory network, a sequence model can model full-order interaction in a nonlocal operation manner within a sequence data segment, and update information in a gated manner among sequence data segments to model global interaction, so that a long-term dependency relationship can be captured, and potential high-dimensional features included in high-order interaction can be further refined.

For ease of description, the foregoing method embodiments are stated as a combination of a series of actions. However, a person skilled in the art is to learn that this disclosure is not limited to the described action sequence, because according to this disclosure, some steps may be performed in another sequence or simultaneously. In addition, a person skilled in the art is also to understand that the embodiments described in this specification are all exemplary embodiments, and the involved actions and modules are not necessarily required to this disclosure.

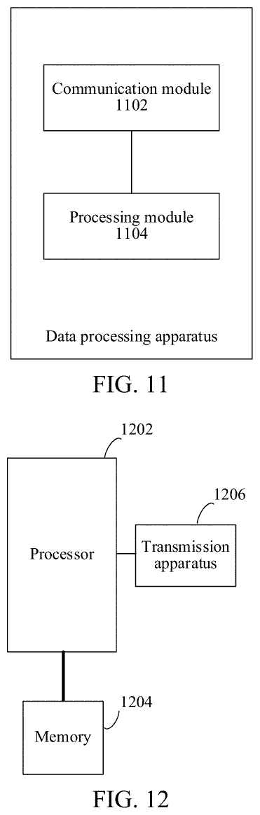

According to another aspect of the embodiments of this disclosure, a data processing apparatus configured to perform the data processing method is further provided. As shown in FIG. 11, the apparatus can include a communication module 1102 and a processing module 1104. One or more of modules, submodules, and/or units of the apparatus can be implemented by processing circuitry, software, or a combination thereof, for example.

The communication module 1102 is configured to obtain target sequence data, the target sequence data including N groups of data sorted in chronological order, N being greater than 1.

The processing module 1104 is configured to process, according to the i^{th} group of data in the N groups of data, processing results of a target neural network model for the i^{th} group of data, and a processing result of the target neural network model for the j^{th} piece of data in the (i+1)^{th} group of data, the (j+1)^{th} piece of data in the (i+1)^{th} group of data by using the target neural network model, to obtain a processing result of the target neural network model for the (j+1)^{th} piece of data in the (i+1)^{th} group of data, i being greater than or equal to 1 and less than N, and j being greater than or equal to 1 and less than Q, Q being a quantity of pieces of data in the (i+1)^{th} group of data.

For example, the data processing apparatus may be applied to a process of executing a target task by using a target neural network, but this disclosure is not limited thereto. The target task may be to determine an execution result of a target task according to information of the target sequence data on a time series. For example, the target task may be video understanding classification, abnormal action detection, text analysis (e.g., sentiment classification), a dialog system, or the like.

In some embodiments, the communication module 1102 may be configured to perform step S202, and the processing module 1104 may be configured to perform step S204 and step S206.

In this embodiment, the target neural network model processes current data according to a previous group of data of a current group of data, a previous group of processing results obtained by processing the previous group of data by using the target neural network model, and a previous processing result obtained by processing a previous piece of data of the current data by using the target neural network model, so that a problem that a sequence model in the related art cannot model a long-term dependency relationship is resolved, and a long-term dependency relationship is captured, thereby modeling the long-term dependency relationship, and improving modeling accuracy. Therefore, a model obtained by using this method can be widely applied to scenarios such as visual processing, text analysis, and a dialog system.

In an exemplary implementation, the processing module 1104 includes: a first processing unit, a second processing unit, and a third processing unit.

The first processing unit is configured to process the i^{th} group of data in the N groups of data and the processing results of the target neural network model for the i^{th} group of data by using a target self-attention model in a target processing model, to obtain second feature information.

The second processing unit is configured to process the second feature information and third feature information by using a first gate in the target processing model, to obtain first feature information, the first feature information being intra-group feature information of the (i+1)^{th} group of data, the third feature information being intra-group feature information of the i^{th} group of data, the first gate being configured to control a proportion of the second feature information outputted to the first feature information and a proportion of the third feature information outputted to the first feature information.

The third processing unit is configured to process, according to the first feature information and the processing result of the target neural network model for the j^{th} piece of data in the (i+1)^{th} group of data, the (j+1)^{th} piece of data in the (i+1)^{th} group of data by using the target neural network model.

In this embodiment, a relationship between the previous group of data and the previous group of processing results and an information matching degree between processing results in the previous group of processing results are modeled by using the target self-attention model, and the first gate is used to control an information process among sequence data segments, thereby ensuring accuracy in modeling of a long-term dependency relationship.

In an exemplary implementation, the third processing unit is specifically configured to process the first feature information and the (j+1)^{th} piece of data in the (i+1)^{th} group of data by using a second gate, to obtain a target parameter, the second gate being configured to control a proportion of the first feature information outputted to the target parameter and a proportion of the (j+1)^{th} piece of data outputted to the target parameter. The third processing unit is further configured to process the target parameter by using the target neural network model.

In this embodiment, a gate (the second gate) is added to a target neural network, to introduce first feature information for updating a current hidden state, so that long-distance sequence information can also be well captured in a current time step.

In an optional implementation, the apparatus further includes: a sliding module, configured to: after the target sequence data is obtained, use a target sliding window to slide on the target sequence data according to a target stride, to obtain the N groups of data.

In this embodiment, the target sliding window is used to slide on the target sequence data according to the target stride, to obtain a plurality of groups of data, which facilitates dividing the target sequence data into groups, thereby improving processing efficiency for the target sequence data.

In an exemplary implementation, the communication module 1102 is specifically configured to obtain target video data, the target video data including N video frame groups sorted in chronological order and being used for recognizing an action performed by a target object in the target video data.

The apparatus further includes a first determining module, configured to determine first probability information according to a processing result for at least one video frame in at least one of the N video frame groups, the first probability information being used for representing a probability that the action performed by the target object is each reference action in a reference action set; and determine, according to the first probability information, that the action performed by the target object is a target action in the reference action set.

In an exemplary implementation, the communication module 1102 is specifically configured to obtain target text data, the target text data including at least one sentence, the at least one sentence including N sequential phrases, and the target text data being used for recognizing a sentiment class expressed by the target text data.

The apparatus further includes a second determining module, configured to determine second probability information according to a processing result for at least one word in at least one of the N phrases, the second probability information being used for representing a probability that the sentiment class expressed by the target text data is each reference sentiment class in a reference sentiment class set; and determine, according to the second probability information, that the sentiment class expressed by the target text data is a target sentiment class in the reference sentiment class set.

In this embodiment, different target sequence data is obtained for different types of target tasks, and execution results of the different types of target tasks are determined for the target tasks, so that different types of task requirements can be met, thereby improving applicability of the sequence model.

According to still another aspect of the embodiments of this disclosure, a storage medium is further provided, the storage medium storing a computer program, the computer program being configured to perform steps in any one of the foregoing method embodiments when being run.

In some embodiments, the storage medium may be configured to store a computer program for performing the following steps:

A step S1 to obtain target sequence data, the target sequence data including N groups of data sorted in chronological order, N being greater than 1.

A step S2 to process, according to the i^{th} group of data in the N groups of data, processing results of a target neural network model for the i^{th} group of data, and a processing result of the target neural network model for the j^{th} piece of data in the (i+1)^{th} group of data, the (j+1)^{th} piece of data in the (i+1)^{th} group of data by using the target neural network model, to obtain a processing result of the target neural network model for the (j+1)^{th} piece of data in the (i+1)^{th} group of data, i being greater than or equal to 1 and less than N, and j being greater than or equal to 1 and less than Q, Q being a quantity of pieces of data in the (i+1)^{th} group of data.

For example, in this embodiment, a person of ordinary skill in the art may understand that all or some of the steps of the methods in the foregoing embodiments may be implemented by a program instructing relevant hardware of the terminal device. The program may be stored in a computer-readable storage medium such as a non-transitory computer-readable storage medium. The storage medium may include a flash disk, a read-only memory (ROM), a random access memory (RAM), a magnetic disk, an optical disk, and the like.

According to still another aspect of the embodiments of this disclosure, an electronic device configured to implement the foregoing data processing method is further provided. As shown in FIG. 12, the electronic device includes: a processor 1202, a memory 1204, and a transmission apparatus 1206. The memory stores a computer program, and the processor or other processing circuitry can be configured to perform steps in any one of the foregoing method embodiments by using the computer program.

The electronic device may be located in at least one of a plurality of network devices in a computer network.

The transmission apparatus 1206 is configured to obtain target sequence data, the target sequence data including N groups of data sorted in chronological order, N being greater than 1.

The processor may be configured to perform the following step by using the computer program: processing, according to the i^{th} group of data in the N groups of data, processing results of a target neural network model for the i^{th} group of data, and a processing result of the target neural network model for the j^{th} piece of data in the (i+1)^{th} group of data, the (j+1)^{th} piece of data in the (i+1)^{th} group of data by using the target neural network model, to obtain a processing result of the target neural network model for the (j+1)^{th} piece of data in the (i+1)^{th} group of data, i being greater than or equal to 1 and less than N, and j being greater than or equal to 1 and less than Q, Q being a quantity of pieces of data in the (i+1)^{th} group of data.

A person of ordinary skill in the art may understand that, the structure shown in FIG. 12 is only illustrative. The electronic device may also be a terminal device such as a smartphone (e.g., an Android mobile phone or an iOS mobile phone), a tablet computer, a palmtop computer, a mobile Internet device (MID), or a PAD. FIG. 12 does not constitute a limitation on the structure of the electronic device. For example, the electronic device may further include more or fewer components (e.g., a network interface) than those shown in FIG. 12, or have a configuration different from that shown in FIG. 12.

The memory 1204 may be configured to store a software program and module, for example, a program instruction/module corresponding to the data processing method and apparatus in the embodiments of this disclosure. The processor 1202 runs the software program and module stored in the memory 1204, to implement various functional applications and data processing, that is, implement the foregoing data processing method. The memory 1204 may include a high-speed random access memory, and may also include a non-volatile memory, for example, one or more magnetic storage apparatuses, a flash memory, or another nonvolatile solid-state memory. In some embodiments, the memory 1204 may further include memories remotely disposed relative to the processor 1202, and the remote memories may be connected to a terminal by using a network. Examples of the network include, but are not limited to, the Internet, an intranet, a local area network, a mobile communication network, and a combination thereof.

The transmission apparatus 1206 is configured to receive or transmit data by using a network. Specific examples of the foregoing network may include a wired network and a wireless network. In an example, the transmission apparatus 1206 includes a network interface controller (NIC). The NIC may be connected to another network device and a router by using a network cable, so as to communicate with the Internet or a local area network. In an example, the transmission apparatus 1206 is a radio frequency (RF) module, which communicates with the Internet in a wireless manner.

The sequence numbers of the foregoing embodiments of this disclosure are merely for description purpose but do not imply any preference among the embodiments.

When the integrated unit in the foregoing embodiments is implemented in a form of a software functional unit and sold or used as an independent product, the integrated unit may be stored in the foregoing computer-readable storage medium. Based on such an understanding, the technical solutions of this disclosure may be entirely or partially implemented in a form of a software product. The computer software product is stored in a storage medium and includes several instructions for instructing one or more computer devices (which may be a personal computer, a server, a network device, or the like) to perform all or some of the steps of the methods described in the embodiments of this disclosure.

In the foregoing embodiments of this disclosure, the descriptions of the embodiments have respective focuses. For a part that is not described in detail in an embodiment, refer to related descriptions in other embodiments as examples.

In the several embodiments provided in this disclosure, it is to be understood that, the disclosed client may be implemented in another manner. The described apparatus embodiment is merely exemplary. For example, the unit division is merely logical function division and may be other division during actual implementation. For example, a plurality of units or components may be combined or integrated into another system, or some features may be ignored or not performed. In addition, the coupling, or direct coupling, or communication connection between the displayed or discussed components may be the indirect coupling or communication connection by means of some interfaces, units, or modules, and may be electrical or of other forms.

The units described as separate components may or may not be physically separate, and components displayed as units may or may not be physical units, may be located in one position, or may be distributed on a plurality of network units. Some or all of the units may be selected according to actual needs to achieve the objectives of the solutions of the embodiments.

In addition, functional units in the embodiments of this disclosure may be integrated into one processing unit, or each of the units may be physically separated, or two or more units may be integrated into one unit. The integrated unit may be implemented in the form of hardware, or may be implemented in a form of a software functional unit.

The foregoing descriptions are exemplary implementations of this disclosure. A person of ordinary skill in the art may further make several improvements and refinements without departing from the principle of this disclosure, and the improvements and refinements shall fall within the protection scope of this disclosure.

What is claimed is:

1. A data processing method, comprising:
obtaining target sequence data, the target sequence data comprising N groups of data sorted in chronological order, N being greater than 1; and
processing by processing circuitry, according to an i^{th} group of data in the N groups of data, processing results of a target neural network model for the i^{th} group of data, and a processing result of the target neural network model for a j^{th} piece of data in an (i+1)^{th} group of data, a (j+1)^{th} piece of data in the (i+1)^{th} group of data by using the target neural network model, to obtain a processing result of the target neural network model for the (j+1)^{th} piece of data in the (i+1)^{th} group of data, i being greater than or equal to 1 and less than N, and j being greater than or equal to 1 and less than Q, Q being a quantity of pieces of data in the (i+1)^{th} group of data.

2. The method according to claim 1, wherein the processing comprises:
processing the i^{th} group of data in the N groups of data and the processing results of the target neural network model for the i^{th} group of data by using a target self-attention model in a target processing model, to obtain second feature information;
processing the second feature information and third feature information by using a first gate in the target processing model, to obtain first feature information, the first feature information being intra-group feature information of the (i+1)^{th} group of data, the third feature information being intra-group feature information of the i^{th} group of data, the first gate being configured to control a proportion of the second feature information outputted to the first feature information and a proportion of the third feature information outputted to the first feature information; and
processing, according to the first feature information and the processing result of the target neural network model for the j^{th} piece of data in the (i+1)^{th} group of data, the (j+1)^{th} piece of data in the (i+1)^{th} group of data by using the target neural network model.

3. The method according to claim 2, wherein the processing, according to the first feature information and the processing result of the target neural network model for the j^{th} piece of data in the (i+1)^{th} group of data, the (j+1)^{th} piece of data comprises:
processing the first feature information and the (j+1)^{th} piece of data in the (i+1)^{th} group of data by using a second gate, to obtain a target parameter, the second gate being configured to control a proportion of the first feature information outputted to the target parameter and a proportion of the (j+1)^{th} piece of data outputted to the target parameter; and
processing the target parameter by using the target neural network model.

4. The method according to claim 1, wherein after the target sequence data is obtained, the method further comprises:
obtaining the N groups of data according to a target sliding window applied to the target sequence data.

5. The method according to claim 1, wherein
the target sequence data is target video data, the target video data comprising N video frame groups sorted in chronological order and being used for recognizing an action performed by a target object in the target video data; and
the method further comprises:
determining first probability information according to a processing result for at least one video frame in at least one of the N video frame groups, the first probability information indicating a probability that the action performed by the target object is each reference action in a reference action set; and
determining, according to the first probability information, that the action performed by the target object is a target action in the reference action set.

6. The method according to claim 1, wherein
the target sequence data is target text data, the target text data comprising at least one sentence, the at least one sentence comprising N sequential phrases, and the target text data being used for recognizing a sentiment class expressed by the target text data; and
the method further comprises:
determining second probability information according to a processing result for at least one word in at least one of the N sequential phrases, the second probability information indicating a probability that the sentiment class expressed by the target text data is each reference sentiment class in a reference sentiment class set; and
determining, according to the second probability information, that the sentiment class expressed by the target text data is a target sentiment class in the reference sentiment class set.

7. The method according to claim 1, further comprising:
sequentially inputting each piece of data in the N groups of data into the target neural network model; and
determining a recognition result based on an output result of the target neural network model of a last piece of data in the N groups of data that is input into the target neural network model.

8. A data processing apparatus, comprising:
processing circuitry configured to:
obtain target sequence data, the target sequence data comprising N groups of data sorted in chronological order, N being greater than 1; and
process, according to an i^{th} group of data in the N groups of data, processing results of a target neural network model for the i^{th} group of data, and a processing result of the target neural network model for a j^{th} piece of data in an (i+1)^{th} group of data, a (j+1)^{th} piece of data in the (i+1)^{th} group of data by using the target neural network model, to obtain a processing result of the target neural network model for the (j+1)^{th} piece of data in the (i+1)^{th} group of data, i being greater than or equal to 1 and less than N, and j being greater than or equal to 1 and less than Q, Q being a quantity of pieces of data in the (i+1)^{th} group of data.

9. The data processing apparatus according to claim 8, wherein the processing circuitry is configured to:
process the i^{th} group of data in the N groups of data and the processing results of the target neural network model for the i^{th} group of data by using a target self-attention model in a target processing model, to obtain second feature information;
process the second feature information and third feature information by using a first gate in the target processing model, to obtain first feature information, the first feature information being intra-group feature information of the (i+1)^{th} group of data, the third feature information being intra-group feature information of the i^{th} group of data, the first gate being configured to control a proportion of the second feature information outputted to the first feature information and a proportion of the third feature information outputted to the first feature information; and
process, according to the first feature information and the processing result of the target neural network model for the i^{th} piece of data in the (i+1)^{th} group of data, the (j+1)^{th} piece of data in the (i+1)^{th} group of data by using the target neural network model.

10. The data processing apparatus according to claim 9, wherein the processing circuitry is configured to:
process the first feature information and the (j+1)^{th} piece of data in the (i+1)^{th} group of data by using a second gate, to obtain a target parameter, the second gate being configured to control a proportion of the first feature information outputted to the target parameter and a proportion of the (j+1)^{th} piece of data outputted to the target parameter; and
process the target parameter by using the target neural network model.

11. The data processing apparatus according to claim 8, wherein after the target sequence data is obtained, the processing circuitry is configured to:
obtain the N groups of data according to a target sliding window applied to the target sequence data.

12. The data processing apparatus according to claim 8, wherein
the target sequence data is target video data, the target video data comprising N video frame groups sorted in chronological order and being used for recognizing an action performed by a target object in the target video data; and
the processing circuitry is configured to:
determine first probability information according to a processing result for at least one video frame in at least one of the N video frame groups, the first probability information indicating a probability that the action performed by the target object is each reference action in a reference action set; and
determine, according to the first probability information, that the action performed by the target object is a target action in the reference action set.

13. The data processing apparatus according to claim 8, wherein
the target sequence data is target text data, the target text data comprising at least one sentence, the at least one sentence comprising N sequential phrases, and the target text data being used for recognizing a sentiment class expressed by the target text data; and
the processing circuitry is configured to:
determine second probability information according to a processing result for at least one word in at least one of the N sequential phrases, the second probability information indicating a probability that the sentiment class expressed by the target text data is each reference sentiment class in a reference sentiment class set; and
determine, according to the second probability information, that the sentiment class expressed by the target text data is a target sentiment class in the reference sentiment class set.

14. The data processing apparatus according to claim 8, wherein the processing circuitry is configured to:
sequentially input each piece of data in the N groups of data into the target neural network model; and
determine a recognition result based on an output result of the target neural network model of a last piece of data in the N groups of data that is input into the target neural network model.

15. A non-transitory computer-readable storage medium, storing instructions which when executed by a processor cause the processor to perform:
obtaining target sequence data, the target sequence data comprising N groups of data sorted in chronological order, N being greater than 1; and
processing, according to an i^{th} group of data in the N groups of data, processing results of a target neural network model for the i^{th} group of data, and a processing result of the target neural network model for a j^{th} piece of data in an (i+1)^{th} group of data, a (j+1)^{th} piece of data in the (i+1)^{th} group of data by using the target neural network model, to obtain a processing result of the target neural network model for the (j+1)^{th} piece of data in the (i+1)^{th} group of data, i being greater than or equal to 1 and less than N, and j being greater than or equal to 1 and less than Q, Q being a quantity of pieces of data in the (i+1)^{th} group of data.

16. The non-transitory computer-readable storage medium according to claim 15, wherein the processing comprises:
processing the i^{th} group of data in the N groups of data and the processing results of the target neural network model for the i^{th} group of data by using a target self-attention model in a target processing model, to obtain second feature information;
processing the second feature information and third feature information by using a first gate in the target processing model, to obtain first feature information, the first feature information being intra-group feature information of the (i+1)^{th} group of data, the third feature information being intra-group feature information of the i^{th} group of data, the first gate being configured to control a proportion of the second feature information outputted to the first feature information and a proportion of the third feature information outputted to the first feature information; and
processing, according to the first feature information and the processing result of the target neural network model for the j^{th} piece of data in the (i+1)^{th} group of data, the (j+1)^{th} piece of data in the (i+1)^{th} group of data by using the target neural network model.

17. The non-transitory computer-readable storage medium according to claim 16, wherein the processing, according to the first feature information and the processing result of the target neural network model for the j^{th} piece of data in the (i+1)^{th} group of data, the (j+1)^{th} piece of data comprises:
processing the first feature information and the (j+1)^{th} piece of data in the (i+1)^{th} group of data by using a second gate, to obtain a target parameter, the second gate being configured to control a proportion of the first feature information outputted to the target parameter and a proportion of the (j+1)^{th} piece of data outputted to the target parameter; and
processing the target parameter by using the target neural network model.

18. The non-transitory computer-readable storage medium according to claim 15, wherein after the target sequence data is obtained, the instructions further cause the processor to perform:
obtaining the N groups of data according to a target sliding window applied to the target sequence data.

19. The non-transitory computer-readable storage medium according to claim 15, wherein
the target sequence data is target video data, the target video data comprising N video frame groups sorted in chronological order and being used for recognizing an action performed by a target object in the target video data; and
the instructions further cause the processor to perform:
determining first probability information according to a processing result for at least one video frame in at least one of the N video frame groups, the first probability information indicating a probability that the action performed by the target object is each reference action in a reference action set; and
determining, according to the first probability information, that the action performed by the target object is a target action in the reference action set.

20. The non-transitory computer-readable storage medium according to claim 15, wherein
the target sequence data is target text data, the target text data comprising at least one sentence, the at least one sentence comprising N sequential phrases, and the target text data being used for recognizing a sentiment class expressed by the target text data; and
the instructions further cause the processor to perform:
determining second probability information according to a processing result for at least one word in at least one of the N sequential phrases, the second probability information indicating a probability that the sentiment class expressed by the target text data is each reference sentiment class in a reference sentiment class set; and
determining, according to the second probability information, that the sentiment class expressed by the target text data is a target sentiment class in the reference sentiment class set.
